(19) United States
(12) Patent Application Publication
(10) Pub. No.: US 2017/0357063 A1
(43) Pub. Date: Dec. 14, 2017

(54) OPTICAL MODULE AND OPTICAL MODULE MANUFACTURING METHOD

(71) Applicant: FUJITSU LIMITED, Kawasaki-shi (JP)

(72) Inventors: Shuichi Takeuchi, Chikuma (JP); NAOKI ISHIKAWA, Nagano (JP); TAKATOYO YAMAKAMI, Nagano (JP); Kimio Nakamura, Suzaka (JP); Hiroshi Kobayashi, Kawasaki (JP); TETSUYA TAKAHASHI, Nagano (JP)

(73) Assignee: FUJITSU LIMITED, Kawasaki-shi (JP)

(21) Appl. No.: 15/487,479

(22) Filed: Apr. 14, 2017

(30) Foreign Application Priority Data
Jun. 13, 2016 (JP) 2016-117271

(51) Int. Cl. G02B 6/42

(52) U.S. Cl. CPC G02B 6/4206; G02B 6/4255; G02B 6/4239; G02B 6/4214; G02B 6/4245

(57) ABSTRACT

An optical module includes a substrate with a through-hole formed therein, an optical element member that includes a light receiving or emitting part that receives light or emits light at a position on a surface that is opposite to the substrate, the position corresponding to the through-hole, and a post that is formed of a transparent material, covers the light receiving or emitting part and is inserted into the through-hole.

### CROSS-REFERENCE TO RELATED APPLICATION

This application is based upon and claims the benefit of priority of the prior Japanese Patent Application No. 2016-117271, filed on Jun. 13, 2016, the entire contents of which are incorporated herein by reference.

### FIELD

The embodiment discussed herein is related to an optical module and an optical module manufacturing method.

### BACKGROUND

In recent years, for example, a system with multiple Central Processing Units (CPUs) being connected to execute parallel processing spreads with increasing information capacity. It is preferable to transfer information among such CPUs at a high speed, but no sufficient transfer speed may be obtained in a case where multiple CPUs are connected by a metal cable. Accordingly, multiple CPUs may be connected by an optical cable with a high transfer speed. An optical module that converts information that is processed in a state of an electrical signal into an optical signal or converts a transferred optical signal into an electrical signal is used in order to transfer information through an optical cable.

For example, an optical element member that emits light to transmit an optical signal or an optical element member that receives an optical signal is mounted on an optical module. Specifically, an optical module is formed in such a manner that, for example, an optical element member such as a Vertical Cavity Surface Emitting LASER (VCSEL) or a Photo Diode (PD) is mounted on a printed circuit board. In a case where an optical element member is mounted on a printed circuit board, the optical element member may be arranged in such a manner that a surface on a back side of a light receiving or emitting surface is opposite to the printed circuit board, and be connected to the printed circuit board by a wire bonding method. In such an arrangement, a light receiving or emitting surface of an optical element member is oriented in a direction opposite to that of a printed circuit board, so that light is not blocked by the printed circuit board and an optical signal is transmitted or received reliably.

In a wire bonding method, an optical element member is connected to a printed circuit board by wires that extend around the optical element member, so that a size of the optical element member is increased in order to provide a needed number of wires and the wires also extend around the optical element member to increase a surface area for mounting thereof. Accordingly, flip-chip mounting may be adopted recently, where a light receiving or emitting surface of an optical element member is arranged to be opposite to a printed circuit board and the optical element member is directly connected to the printed circuit board by a bump. In a case where flip-chip mounting is adopted, a light receiving or emitting surface of an optical element member is opposite to a printed circuit board, so that a through-hole is formed in the printed circuit board and an optical signal passes through the through-hole to be transmitted or received.

Japanese Laid-open Patent Publication No. 2001-033666

Japanese Laid-open Patent Publication No. 2002-098863

In a case where an optical element member is flip-chip-mounted on a printed circuit board, an underfill material is caused to fill a gap between the optical element member and the printed circuit board in order to protect a state of bonding between the optical element member and the printed circuit board. However, a light receiving or emitting part of an optical element member is opposite to a printed circuit board in flip-chip mounting, so that there is a problem in that the light receiving or emitting part may be covered by an underfill material that is caused to fill a gap between the optical element member and the printed circuit board. As a light receiving or emitting part is covered by an underfill material, light is blocked by the underfill material, so that normal transmitting or receiving of an optical signal is difficult.

Hence, as filling with an underfill material is executed, an inefficient method may be used in such a manner that, for example, the underfill material is warmed to increase a viscosity thereof and the underfill material with an increased viscosity is manually accumulated around an optical element member in increments of a less amount thereof. As a result, a manufacturing cost of an optical module is increased.

### SUMMARY

According to an aspect of an embodiment, an optical module includes a substrate with a through-hole formed therein, an optical element member that includes a light receiving or emitting part that receives light or emits light at a position on a surface that is opposite to the substrate, the position corresponding to the through-hole, and a post that is formed of a transparent material, covers the light receiving or emitting part and is inserted into the through-hole.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a configuration of an optical module according to an embodiment;

FIG. 2 is a cross-sectional schematic diagram illustrating a configuration of a photoelectric conversion part;

FIG. 3 is an enlarged view illustrating a periphery of an optical element member;

FIG. 4 is a plan view illustrating a periphery of an optical element member;

FIGS. 5A, 5B, 5C, 5D, 5E, and 5F are diagrams illustrating a method for manufacturing an optical element member; and

FIGS. 6A, 6B, and 6C are diagrams illustrating a method for fixing an optical element member to a substrate.

### DESCRIPTION OF EMBODIMENT

Preferred embodiments of the present invention will be explained with reference to accompanying drawings. Additionally, the present invention is not limited by such an embodiment.

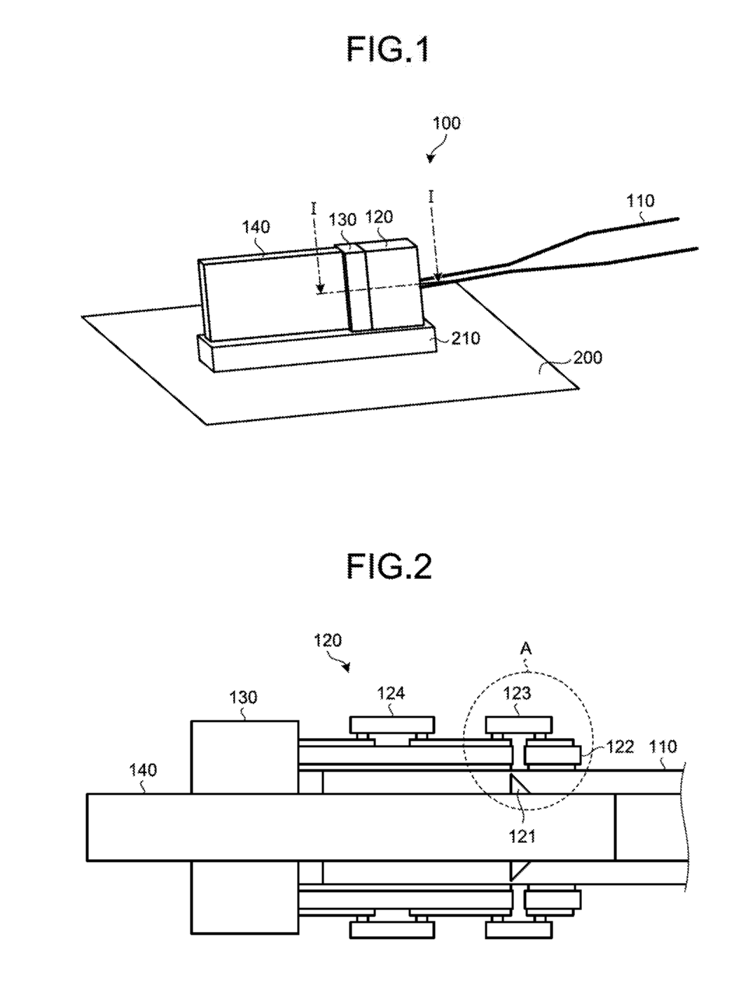

FIG. 1 is a schematic diagram illustrating a configuration of an optical module 100 according to an embodiment. The optical module 100 is disposed on, for example, a connector at an end of an optical cable, or the like. The optical module 100 as illustrated in FIG. 1 is put into, for example, a connector 210 that is included in a substrate 200 of another device such as a server. Furthermore, the optical module 100 includes an optical waveguide 110, a photoelectric conversion part 120, a Flexible Printed Circuit (FPC) connector 130, and a FPC 140.

The optical waveguide 110 is a transmission path that transmits an optical signal. The optical waveguide 110 is composed of a core and a clad that surrounds the core, and transmits an optical signal through the core. The optical waveguide 110 is connected to the photoelectric conversion part 120.

The photoelectric conversion part 120 executes photoelectric conversion between an optical signal that is transmitted by the optical waveguide 110 and an electrical signal. That is, the photoelectric conversion part 120 converts an electrical signal into an optical signal and transmits it to the optical waveguide 110, or converts an optical signal received from the optical waveguide 110 into an electrical signal. A configuration of the photoelectric conversion part 120 will be described in detail later.

The FPC connector 130 connects the photoelectric conversion part 120 to the FPC 140 that is a circuit board. That is, the FPC connector 130 transmits an electrical signal generated by a circuit on the FPC 140 to the photoelectric conversion part 120 or transmits an electrical signal converted from an optical signal by the photoelectric conversion part 120 to a circuit on the FPC 140.

The FPC 140 is a flexible printed circuit board where a wiring pattern is printed or a variety of circuits are formed on a surface thereof. An electrical signal is transmitted by a wiring pattern or a circuit on the FPC 140.

Next, a configuration of the photoelectric conversion part 120 will be described with reference to FIG. 2. FIG. 2 is a schematic diagram illustrating a cross section of the optical module 100 along a line I-I as illustrated in FIG. 1.

As illustrated in FIG. 2, the photoelectric conversion part 120 is connected to the FPC 140 through the FPC connector 130. Furthermore, the optical waveguide 110 is inserted into a gap between the photoelectric conversion part 120 and the FPC 140 and connected to the photoelectric conversion part 120. Moreover, a mirror 121 is provided in the optical waveguide 110 at a position where the photoelectric conversion part 120 is connected thereto. The photoelectric conversion part 120 is formed in such a manner that an optical element member 123 and a conversion control member 124 are mounted on a substrate 122.

The mirror 121 changes a traveling direction of an optical signal transmitted through the optical waveguide 110 to a direction toward the optical element member 123. Furthermore, the mirror 121 changes a traveling direction of an optical signal that is emitted from the optical element member 123 to a direction of extension of the optical waveguide 110. That is, the mirror 121 changes a traveling direction of an optical signal so that the optical element member 123 can transmit or receive the optical signal through the optical waveguide 110.

The substrate 122 is, for example, a printed circuit board capable of printing a wiring pattern of a conductor on a surface of a core member made of a resin. As described later, a through-hole that passes an optical signal therethrough is formed at a position where the substrate 122 is interposed between the mirror 121 and the optical element member 123.

The optical element member 123 is an optical element that includes a light receiving or emitting part. Specifically, the optical element member 123 includes, for example, a Vertical Cavity Surface Emitting LASER (VCSEL) to emit light or includes, for example, a Photo Diode (PD) to receive light. The optical element member 123 is flip-chip-mounted on the substrate 122. Therefore, a light receiving or emitting part of the optical element member 123 is opposite to the substrate 122 and transmits or receives an optical signal through a through-hole formed in the substrate 122.

Thus, the optical element member 123 is flip-chip-mounted on the substrate 122, so that the optical element member 123 is bonded to the substrate 122 by an underfill material. In other words, an underfill material is caused to fill a gap between the optical element member 123 and the substrate 122. However, in the present embodiment, a light receiving or emitting part of the optical element member 123 is protected by a transparent post as described later, so that the light receiving or emitting part is not covered by an underfill material. As a result, light is not blocked between a light receiving or emitting part of the optical element member 123 and the mirror 121, so that traveling of an optical signal is not prevented.

The conversion control member 124 is electrically connected to the optical element member 123 and controls the optical element member 123 or converts an output signal from the optical element member 123. Specifically, the conversion control member 124 includes a driver that drives a VCSEL of the optical element member 123 or includes a Trance-Impedance Amplifier (TIA) that converts a current signal that is output from a PD of the optical element member 123 into a voltage signal. The conversion control member 124 transmits to or receives from a circuit on the FPC 140 through the FPC connector 130, an electrical signal.

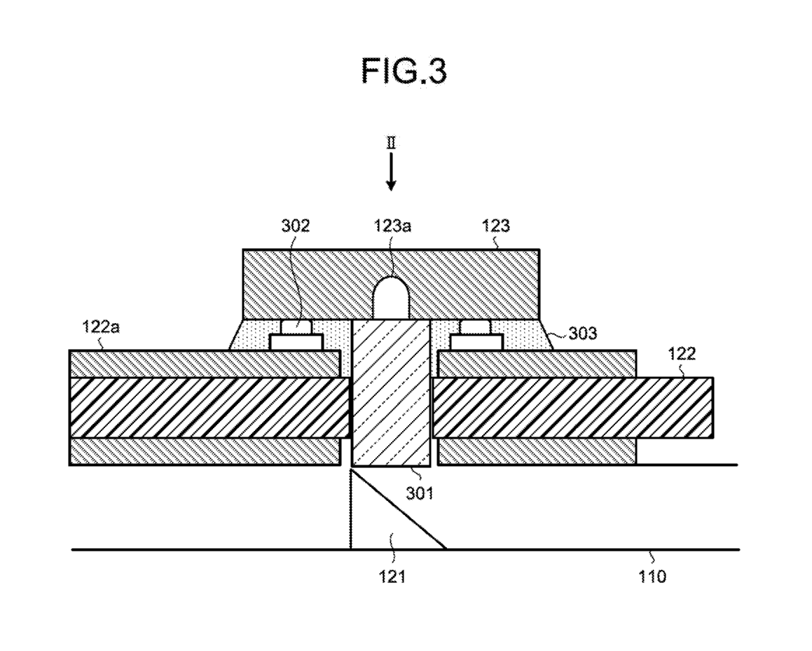

Next, a part A around the optical element member 123 will be described in detail with reference to FIGS. 3 and 4. FIG. 3 is an enlarged view illustrating a part A in FIG. 2. Furthermore, FIG. 4 is a plan view of a periphery of the optical element member 123 when viewed in a direction of II as illustrated in FIG. 3.

As illustrated in FIG. 3, the optical element member 123 includes a light receiving or emitting part 123a and is flip-chip-mounted on the substrate 122. That is, a light receiving or emitting surface of the light receiving or emitting part 123a that receives light or emits light is opposite to the substrate 122, and the optical element member 123 is electrically connected to a wiring pattern 122a on a surface of the substrate 122 by a bump 302. Furthermore, a through-hole is formed at a position where the substrate 122 is interposed between the light receiving or emitting part 123a and the mirror 121. An optical signal that travels between the light receiving or emitting part 123a and the mirror 121 passes through a through-hole formed in the substrate 122.

The light receiving or emitting part 123a of the optical element member 123 is covered by a transparent post 301, and the transparent post 301 is inserted into a through-hole formed in the substrate 122. The transparent post 301 is provided by molding a resin that is transparent and has a less amount of attenuation of light, and is formed of, for example, a ultraviolet ray curable resin that is cured by irradiating it with an ultraviolet ray, or the like. The transparent post 301 covers a whole of the light receiving or emitting part 123a of the optical element member 123, is positioned between the light receiving or emitting part 123a and the mirror 121, and provides a passage for an optical signal.

An underfill material 303 is caused to fill a gap between the optical element member 123 and the substrate 122 to bond the optical element member 123 to the substrate 122. Herein, the light receiving or emitting part 123a of the optical element member 123 is covered by the transparent post 301, so that the light receiving or emitting part 123a is not covered by the underfill material 303. Hence, at the light receiving or emitting part 123a, light is not blocked by the underfill material 303. That is, light that is received or emitted by the light receiving or emitting part 123a passes through an inside of the transparent post 301, so that traveling of an optical signal between the light receiving or emitting part 123a and the mirror 121 is not prevented.

Specifically, an optical signal transmitted through the optical waveguide 110 is reflected from the mirror 121 and is incident on the transparent post 301. Then, an optical signal that travels inside the transparent post 301 is received by the light receiving or emitting part 123a. Furthermore, an optical signal that is emitted from the light receiving or emitting part 123a travels inside of the transparent post 301 and is output from an end of the transparent post 301 to the mirror 121. Then, an optical signal is reflected from the mirror 121 and transmits through the optical waveguide 110.

Thus, the light receiving or emitting part 123a is covered by the transparent post 301, so that the transparent post 301 that is transparent and has a less amount of attenuation of light is a passage for an optical signal and blocking of light by the underfill material 303 can be prevented.

Additionally, as illustrated in FIG. 4, the optical element member 123 may include multiple light receiving or emitting parts 123a, where each of the light receiving or emitting parts 123a may be a light emitting part that includes a VCSEL or may be a light receiving part that includes a PD. Light emitting or light receiving by the light receiving or emitting parts 123a are controlled by the conversion control member 124 that is connected to the optical element member 123 through the wiring pattern 122a.

Any of these light receiving or emitting parts 123a is protected by the transparent post 301. Herein, for the multiple light receiving or emitting parts 123a, separate transparent posts 301 may be provided respectively, or one transparent post 301 may be provided collectively.

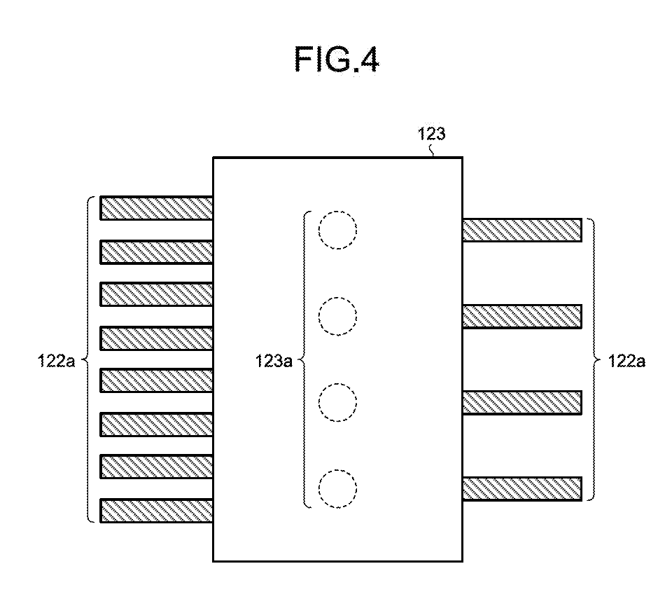

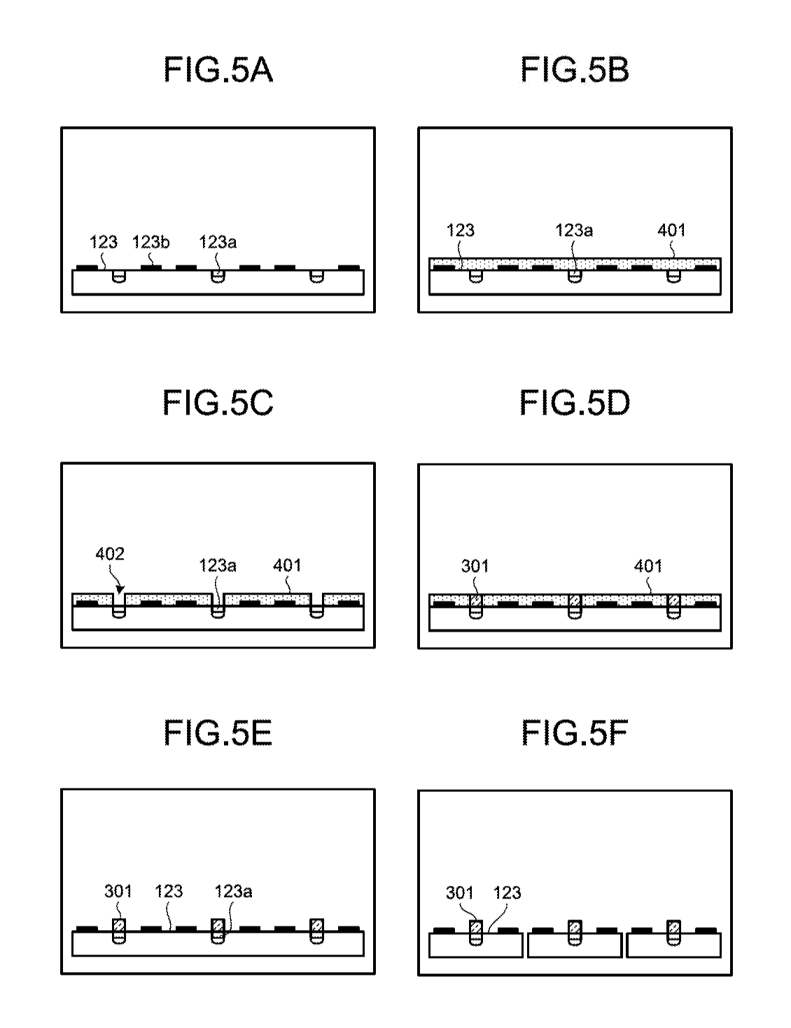

Next, a method for manufacturing the optical element member 123 will be described with reference to FIGS. 5A, 5B, 5C, 5D, 5E, and 5F. FIGS. 5A, 5B, 5C, 5D, 5E, and 5F are diagrams illustrating steps (A) to (F) in a case where the optical element member 132 is manufactured.

First, light receiving or emitting parts 123a, terminals 123b, and the like that correspond to multiple optical element members 123 are formed on a wafer that is a semiconductor substrate (step (A)). Then, a photoresist is applied onto layers of the light receiving or emitting parts 123a, the terminals 123b, and the like to form a resist 401 (step (B)). As the resist 401 is formed, development thereof is executed at positions 402 that correspond to the light receiving or emitting parts 123a and the resist 401 at positions of the light receiving or emitting parts 123a is eliminated (step (C)).

In such a state, for example, a transparent resin such as an ultraviolet ray curable resin is injected at the positions 402 where the resist 401 has been eliminated, and irradiated with light such as an ultraviolet ray as needed. Thereby, transparent posts 301 are formed at positions that correspond to the light receiving or emitting parts 123a (step (D)). Additionally, the transparent posts 301 need not be formed of an ultraviolet ray curable resin, and may be formed of, for example, a thermosetting resin or the like, as long as such a material is transparent and has an amount of attenuation of light that is less than a predetermined reference thereof.

As the transparent posts 301 are formed, a surrounding resist 401 is stripped (step (E)). Thereby, multiple optical element members 123 are produced where respective light receiving or emitting parts 123a are protected by the transparent posts 301. Then, these multiple optical element members 123 are cut into pieces by, for example, a diamond blade, so that the optical element members 123 are completed (step (F)).

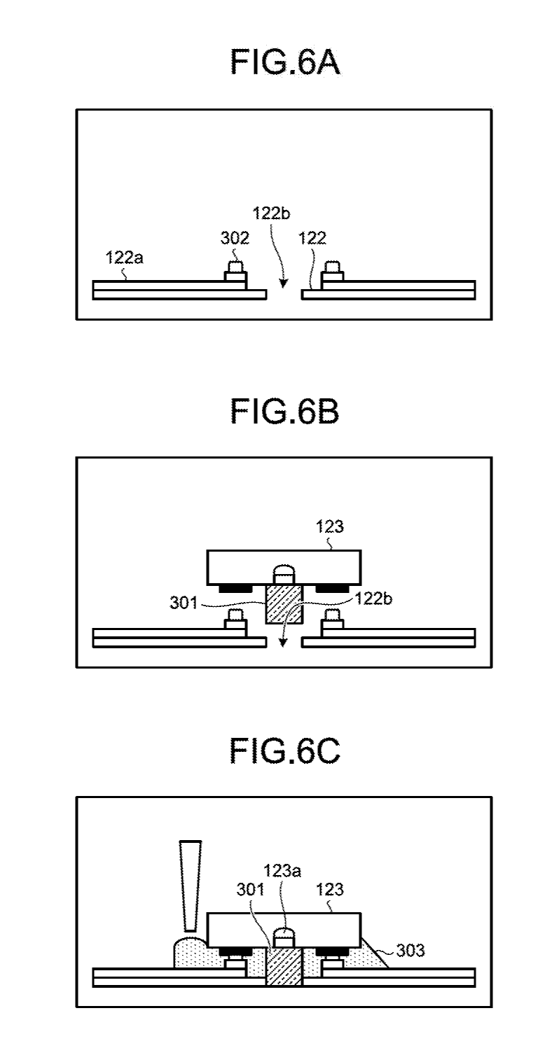

Thus manufactured optical element member 123 is flip-chip-mounted on a substrate 122. As illustrated in FIG. 6A, a wiring pattern 122a is formed on the substrate 122 and a through-hole 122b is formed at a position that corresponds to a light receiving or emitting part 123a of the optical element member 123. Moreover, a metal bump 302 is formed on the wiring pattern 122a in order to flip-chip-mount the optical element member 123. The bump 302 is formed at a position that corresponds to a terminal 123b of the optical element members 123.

Then, as illustrated in FIG. 6B, the optical element member 123 is mounted on the substrate 122. Herein, alignment is executed in such a manner that the transparent post 301 is inserted into the through-hole 122b of the substrate 122 and the terminal 123b contacts the bump 302. As the optical element member 123 is mounted at a suitable position, an underfill material 303 is caused to fill a gap between the substrate 122 and the optical element member 123 as illustrated in FIG. 6C. Herein, the light receiving or emitting part 123a is protected by a transparent post 301, so that the light receiving or emitting part 123a is not covered by the underfill material 303. Therefore, in a case where filling with the underfill material 303 is executed, increasing a viscosity of the underfill material 303 by warming thereof or manually accumulating the underfill material 303 in increments of a less amount thereof is not needed. Thus, filling with the underfill material 303 is readily executed by a machine operation, so that fixing of the optical element member 123 to the substrate 122 is executed efficiently.

As described above, according to the present embodiment, a transparent post that covers a light receiving or emitting part of an optical element member is formed, the optical element member is flip-chip-mounted on a substrate in such a manner that a light receiving or emitting surface at a side of the light receiving or emitting part is opposite to the substrate, and an undefill material is caused to fill a gap between the optical element member and the substrate. Hence, a light receiving or emitting part of an optical element member is protected by a transparent post, so that the light receiving or emitting part is not covered by an underfill material even though filling therewith is executed by, for example, a machine operation. In other words, blocking of light on a light receiving or emitting part can be prevented efficiently.

Additionally, it is also possible to apply a configuration as described for the embodiment as described above where a light receiving or emitting part of an optical element member is covered by a transparent post and a light receiving or emitting surface is opposite to a substrate, to a variety of optical modules as well as an optical module that is disposed on an optical cable. Specifically, it is also possible to apply a configuration of the embodiment as described above to, for example, a case where, in an optical transmitter, an optical receiver, or the like, an optical element member is flip-chip-mounted on a substrate, or the like.

According to an aspect of an optical module and an optical module manufacturing method as disclosed in the present application, an advantageous effect is provided in such a manner that blocking of light on a light receiving or emitting part can be prevented efficiently.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

1. An optical module, comprising:
a substrate with a through-hole formed therein;
an optical element member that includes a light receiving or emitting part that receives light or emits light at a position on a surface that is opposite to the substrate, the position corresponding to the through-hole; and
a post that is formed of a transparent material, covers the light receiving or emitting part and is inserted into the through-hole.

2. The optical module according to claim 1, wherein the post is formed of a first resin that is transparent and has an amount of attenuation of light less than a reference value.

3. The optical module according to claim 1, wherein the optical element member is bonded to the substrate by a second resin that is caused to fill a gap between the optical element member and the substrate.

4. The optical module according to claim 1, further comprising:
a mirror that is provided at a position opposite to the light receiving or emitting part thorough the through-hole and reflects a light signal received or emitted by the light receiving or emitting part to change a traveling direction of the light signal; and
an optical waveguide that transmits the light signal reflected by the mirror.

5. An optical module manufacturing method, comprising:
forming a light receiving or emitting part that receives light or emits light on a semiconductor substrate;
forming a resist on a surface on which the light receiving or emitting part is formed;
executing development at a position corresponding to the light receiving or emitting part to eliminate the resist over the light receiving or emitting part;
injecting a transparent resin at a position where the resist is eliminated; and
stripping the resist around the injected transparent resin.

6. The optical module manufacturing method according to claim 5, further comprising:
forming a bump on a substrate with a through-hole formed therein;
connecting an optical element member obtained by stripping the resist around the transparent resin to the substrate through the bump; and
filling a gap between the optical element member and the substrate with a resin different from the transparent resin.
